(19) United States
(12) Patent Application Publication
(10) Pub. No.: US 2016/0365658 A1
(43) Pub. Date: Dec. 15, 2016

(54) CONNECTOR, AND CONNECTION MECHANISM OF FLAT CIRCUIT BODY AND CONNECTOR

(71) Applicant: YAZAKI CORPORATION, Tokyo (JP)

(72) Inventor: Tomohiro Hikosaka, Shizuoka (JP)

(21) Appl. No.: 15/175,918

(22) Filed: Jun. 7, 2016

(30) Foreign Application Priority Data
Jun. 12, 2015 (JP) 2015-119601

(51) Int. Cl. H01R 12/77; H01R 4/02

(52) U.S. Cl. CPC H01R 12/77; H01R 4/02

(57) ABSTRACT

A flat circuit body has engagement holes formed in an end portion. A connector housing includes: engagement protrusions which protrude to engage with the engagement holes and which are formed with a guide portions formed to guide the engagement holes to top portions of the engagement protrusions when the flat circuit body is inserted; a movement regulating portion which regulates movement of the flat circuit body such that the engagement holes are positioned to engage with the engagement protrusions; and a circuit body escape portion in which peripheral portions of the engagement holes are bendable so as to escape from a movement regulating range defined by the movement regulating portion such that engagement between the engagement holes and the engagement protrusions are established and released.

### CROSS-REFERENCE TO RELATED APPLICATION(S)

This application is based on and claims priority from Japanese Patent Application (Application No. 2015-119601) filed on Jun. 12, 2015, the entire contents of which are incorporated herein by reference.

### BACKGROUND

1. Field of the Invention

The present invention relates to a connector connecting an electrode formed in an end portion of a flat circuit body with a terminal in a connector housing, and a connection mechanism of the flat circuit body and the connector.

2. Description of Related Art

In the related art, a flat circuit body such as a flexible printed circuit (FPC) or a flexible flat cable is connected to a connector by a connection mechanism. In the connection mechanism of the flat circuit body and the connector, an end portion of the flat circuit body is inserted into a connector housing of the connector while sliding thereon, so that electrodes formed in the end portion of the flat circuit body can be connected to terminals in the connector housing.

For example, in a connection mechanism of a flat circuit body and a connector disclosed in JP-A-2014-17361, a member called a slider having a lock mechanism with the connector is installed in an end portion of the flat circuit body so that the flat circuit body can be fixed to the connector in a position where the flat circuit body is completely inserted into the connector. Thus, the electric connection state between the flat circuit body and the connector can be maintained.

### SUMMARY

However, according to the connection mechanism of a flat circuit body and a connector disclosed in JP-A-2014-17361, a connector housing, connect pins (terminals), and fixing fixtures for fixing the connector housing to a circuit board are required as a configuration on the connector side. On the other hand, a flat circuit body and a slider are required as a configuration on the flat circuit body side. In addition, the slider is divided into a base portion and a grip member. Accordingly, the number of components increases. As a result, there is a problem that the manufacturing cost increases.

The present invention has been developed in consideration of the aforementioned situation. An object of the invention is to provide a connector capable of suppressing the number of components to thereby reduce the manufacturing cost, and a connection mechanism of a flat circuit body and the connector.

In a first aspect of the present invention, there is provided a connector including: a connector housing to which a flat circuit body including an electrode formed in an end portion thereof is allowed to be slidably inserted; and a terminal which is provided inside the connector housing and which is connected to the electrode when the end portion is inserted into the connector housing, wherein the connector housing includes: a pair of engagement protrusions which protrude to engage, at a position where the flat circuit body has been completely inserted to connect the terminal with the electrode, with a pair of engagement holes formed in both corner portions of the end portion to penetrate the flat circuit body, the engagement protrusions including guide portions formed to guide the pair of engagement holes to top portions of the engagement protrusions when the flat circuit body is inserted; a movement regulating portion which regulates movement of the flat circuit body such that the pair of engagement holes are positioned to engage with the pair of engagement protrusions; and a circuit body escape portion which forms a space or an opening in which peripheral portions of the both corner portions including the pair of engagement holes in the flat circuit body are bendable so as to escape from a movement regulating range defined by the movement regulating portion such that engagement between the engagement hole and the engagement protrusion corresponding to each other is established and released.

In a second aspect of the present invention, there is provided a connection mechanism of a flat circuit body and a connector, the connection mechanism including: a flat circuit body including an electrode formed in an end portion thereof; and a connector including: a connector housing to which the flat circuit body is allowed to be slidably inserted; and a terminal which is provided inside the connector housing and which is connected to the electrode when the end portion is inserted into the connector housing of the connector, wherein the flat circuit body has: a pair of engagement holes formed in both corner portions of the end portion to penetrate the flat circuit body, and wherein the connector housing includes: a pair of engagement protrusions which protrude to engage with the pair of engagement holes at a position where the flat circuit body has been completely inserted to connect the terminal with the electrode, the engagement protrusions including guide portions formed to guide the pair of engagement holes to top portions of the engagement protrusions when the flat circuit body is inserted; a movement regulating portion which regulates movement of the flat circuit body such that the pair of engagement holes are positioned to engage with the pair of engagement protrusions; and a circuit body escape portion which forms a space or an opening in which peripheral portions of the both corner portions including the pair of engagement holes in the flat circuit body is bendable so as to escape from a movement regulating range defined by the movement regulating portion such that engagement between the engagement hole and the engagement protrusion corresponding to each other is established and released.

In a third aspect of the present invention, there is provided the connection mechanism of a flat circuit body and a connector according to the second aspect, wherein the connector housing includes an insertion port through which the flat circuit body is allowed to be inserted, wherein the movement regulating portion includes an insertion path formed around the pair of engagement protrusions and closer to the insertion port than the pair of engagement protrusions, wherein the insertion path is formed by a pair of walls opposing with a distance slightly larger than thickness of the end portion, and wherein the movement regulating portion regulates movement of the flat circuit body such that the pair of engagement holes are positioned to engage with the pair of engagement protrusions.

In a fourth aspect of the present invention, there is provided the connection mechanism of a flat circuit body and a connector according to the second or third aspect, further including: a jig insertion paths serving as a path in which a jig for releasing engagement is allowed to be inserted into the connector housing from an outside of the connector housing through a jig insertion port such that the peripheral portions of the both corner portions are bent in the circuit body escape portion to release engagement of the engagement hole and the engagement protrusion corresponding to each other.

In a fifth aspect of the present invention, there is provided the connection mechanism of a flat circuit body and a connector according to the fourth aspect, wherein the jig insertion path includes a jig insertion guide slope formed in a surface of the housing from which the pair of engagement protrusions protrude, wherein the jig insertion guide slope is a surface formed to be inclined downward toward the jig insertion port from a vicinity of each of the pair of engagement protrusions, and wherein the jig insertion guide slope guides the jig such that the jig is pressed, in a direction to escape from the movement regulating range defined by the movement regulating portion, against a surface of each of the both corner portions of the flat circuit body in a state in which the pair of engagement holes are engaged with the pair of engagement protrusions.

In a sixth aspect of the present invention, there is provided the connection mechanism of a flat circuit body and a connector according to the fourth or fifth aspect, wherein the circuit body escape portion is an opening formed on a protruding direction side of each of the pair of engagement protrusions so as to allow the peripheral portions of the both corner portions to be bent in a direction to escape from the movement regulating range defined by the movement regulating portion, and wherein the jig insertion path forms an opening which continuously extends from the jig insertion port to the circuit body escape portion.

In a seventh aspect of the present invention, there is provided the connection mechanism of a flat circuit body and a connector according to any one of the second to sixth aspect, wherein the connector housing includes at least a pair of rotation preventing ribs which are fixed to a fixing destination of the connector housing by a fixing fixture, which protrude in opposite directions to each other with respect to the fixing fixture placed therebetween, and which form part of a bottom surface of the connector housing.

In the connector according to the first aspect of the invention, a member called a slider for fixing the flat circuit body with the connector in the position where the flat circuit body and the connector are completely connected to each other is not installed in the end portion of the flat circuit body, but the pair of engagement holes formed in the flat circuit body and the pair of engagement protrusions formed in the connector housing can be engaged with each other in the following manner. That is, due to the effect of the movement regulating portion regulating the movement of the flat circuit body and the guide effect of the guide portions, the peripheral portions of the both corner portions of the flat circuit body can be elastically bent upward in the circuit body escape portions so as not to interfere with the wall of the connector housing. When the peripheral portions of the both corner portions bent thus are elastically restored, the pair of engagement holes and the pair of engagement protrusions can be engaged with each other. Accordingly, the number of components can be suppressed to be small. It is therefore possible to reduce the manufacturing cost.

In the connection mechanism of a flat circuit body and a connector according to the second aspect of the invention, a member called a slider for fixing the flat circuit body with the connector in the position where the flat circuit body and the connector are completely connected to each other is not installed in the end portion of the flat circuit body, but the pair of engagement holes formed in the flat circuit body and the pair of engagement protrusions formed in the connector housing can be engaged with each other in the following manner. That is, due to the effect of the movement regulating portion regulating the movement of the flat circuit body and the guide effect of the guide portions, the peripheral portions of the both corner portions of the flat circuit body can be elastically bent upward in the circuit body escape portions so as not to interfere with the wall of the connector housing. When the peripheral portions of the both corner portions bent thus are elastically restored, the pair of engagement holes and the pair of engagement protrusions can be engaged with each other. Accordingly, the number of components can be suppressed to be small. It is therefore possible to reduce the manufacturing cost.

In the connection mechanism of a flat circuit body and a connector according to the third aspect of the invention, the movement regulating portion forms an insertion path of the end portion around the pair of engagement protrusions and on the insertion port side of the flat circuit body with respect to the pair of engagement protrusions, and the insertion path is formed out of a pair of walls opposed at a distance slightly larger than the thickness of the end portion. Accordingly, the movement of the flat circuit body in the thickness direction is regulated so that the pair of engagement holes can be positioned to engage with the pair of engagement protrusions. It is therefore possible to stably maintain the state where the pair of engagement holes engage with the pair of engagement protrusions.

In the connection mechanism of a flat circuit body and a connector according to the fourth aspect of the invention, the jig is inserted from the outside of the connector housing to the inside thereof by use of each jig insertion path so that the peripheral portions of the both corner portions can be bent in the circuit body escape portions. Thus, the engagement between the engagement holes and the engagement protrusions can be released easily.

In the connection mechanism of a flat circuit body and a connector according to the fifth aspect of the invention, when the engagement between the engagement hole and the engagement protrusion corresponding to each other is released by use of the jig, the front end of the jig is inserted sliding on a corresponding one of the jig insertion guide slopes so that the front end of the jig can be disposed toward the surface of a corresponding one of the corner portions. Accordingly, when the front end of the jig is pressed against the surface to bend the peripheral portion of the corner portion in a direction to escape from the movement regulating range defined by the movement regulating portion, the engagement between the engagement hole and the engagement protrusion corresponding to each other can be released easily.

In the connection mechanism of a flat circuit body and a connector according to the sixth aspect of the invention, an opening can be formed on the protruding direction side of each engagement protrusion so as to continuously extend from the corresponding jig insertion port to the corresponding circuit body escape portion that is an opening. Accordingly, when the jig is inserted into the connector housing, the connector housing can be prevented from easily interfering with the jig. Thus, the jig can be operated more easily to release the engagement between the engagement hole and the engagement protrusion corresponding to each other.

The connection mechanism of a flat circuit body and a connector according to the seventh aspect of the invention, a pair of rotation preventing ribs protrude in opposite directions to each other with respect to each fixing fixture placed therebetween, and form parts of a bottom of the connector housing, so that the connecting area of the connector housing to the fixing destination can be enlarged on the opposite sides of the fixing fixture. Accordingly, the bottoms of the pair of rotation preventing ribs abut against the fixing destination to prevent the connector housing from rotating to the left and right rotation directions respectively when the connector housing is to rotate using the fixing fixture as a fulcrum. Thus, even when each terminal is soldered with the fixing destination by a solder, the solder can be prevented from being damaged by a load applied onto the terminal due to the rotation of the connector housing. As a result, the electric connection between the terminal and the fixing destination can be prevented from lowering.

### BRIEF DESCRIPTION OF THE DRAWINGS

FIG. 1 is an exploded perspective view of a connection mechanism of a flat circuit body and a connector according to an embodiment of the invention.

FIG. 2 is a perspective view of a connector.

FIG. 3 is a perspective view of a flat circuit body observed from a surface where electrodes have been formed.

FIG. 4A is a top view of a connector housing, and FIG. 4B is an enlarged view of the vicinity of an engagement protrusion in the connector housing.

FIG. 5 is a perspective view of the vicinity of the engagement protrusion, which is partially shown in section. FIG. 6 is a sectional view taken on line A-A, showing the connector shown in FIG. 2.

FIG. 7A is a sectional view of the connector and the flat circuit body around an engagement protrusion and an engagement hole that are in engagement with each other, and FIG. 7B is a sectional view of the connector and the flat circuit body, showing a section in a different position from that of FIG. 7A.

FIG. 8A and FIG. 8B are views for explaining that the engagement between the engagement hole and the engagement protrusion is released by use of an engagement release jig. FIG. 8A shows a sectional view of the flat circuit body and the connector, and FIG. 8B shows a perspective view around the engagement hole and the engagement protrusion corresponding to FIG. 8A.

FIG. 9A is a sectional view of the flat circuit body and the connector in a state where inserting an end portion of the flat circuit body into the connector housing of the connector while sliding the end portion thereon has been begun, and FIG. 9B is a sectional view of the flat circuit body and the connector in a state where the flat circuit body in the state of FIG. 9A has been further slid and moved toward an insertion completion position.

FIG. 10A is a sectional view of the flat circuit body and the connector in a state where the flat circuit body in the state of FIG. 9B has been further slid and moved toward the insertion completion position, and FIG. 10B is a sectional view of the flat circuit body and the connector in a state where the flat circuit body has been completely moved to the insertion completion position.

FIG. 11 is an exploded perspective view of a connection mechanism of a flat circuit body and a connector according to Modification 1.

FIG. 12 is a sectional view of the connector and the flat circuit body around an engagement protrusion and an engagement hole that are in engagement with each other in the connection mechanism of a flat circuit body and a connector according to Modification 1.

FIG. 13 is a sectional view of a connection mechanism of a flat circuit body and a connector according to Modification 2.

### DETAILED DESCRIPTION

A preferred embodiment of a connection mechanism of a flat circuit body and a connector according to the invention will be described below in detail with reference to the drawings.

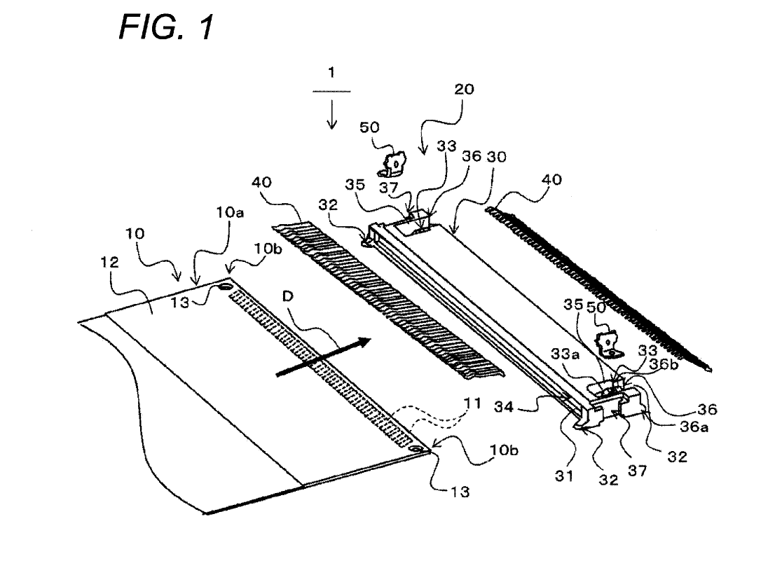

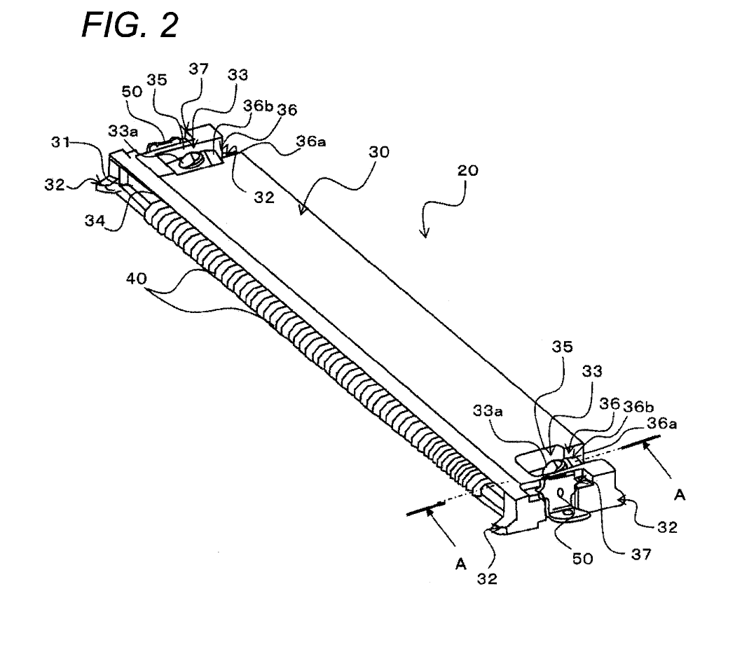

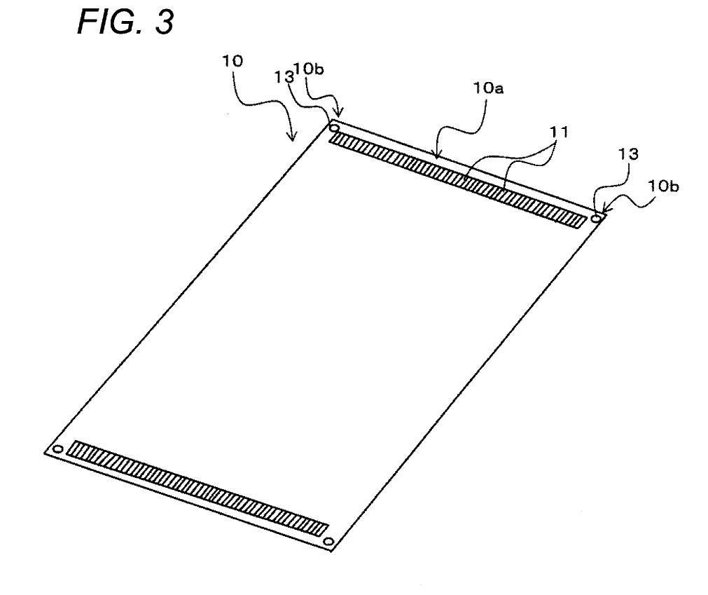

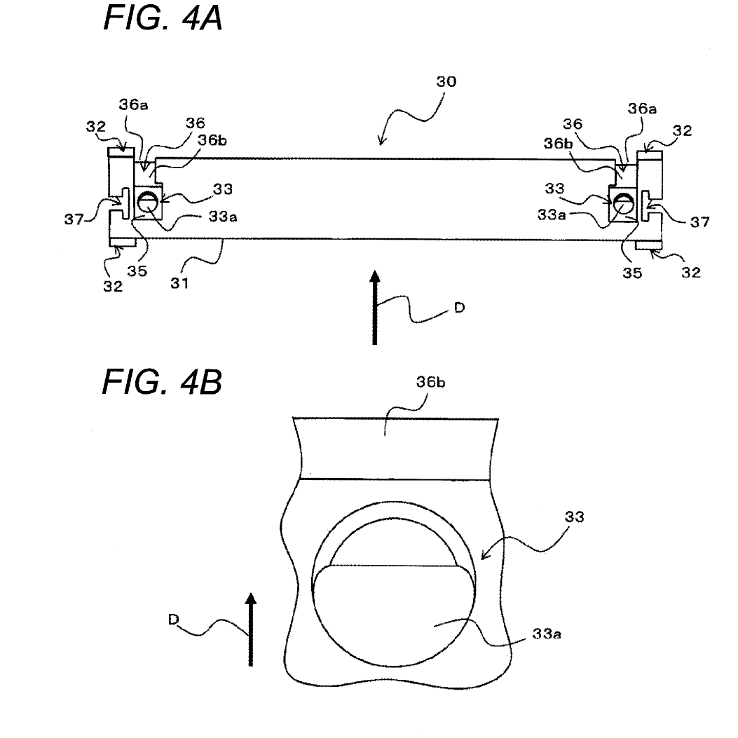

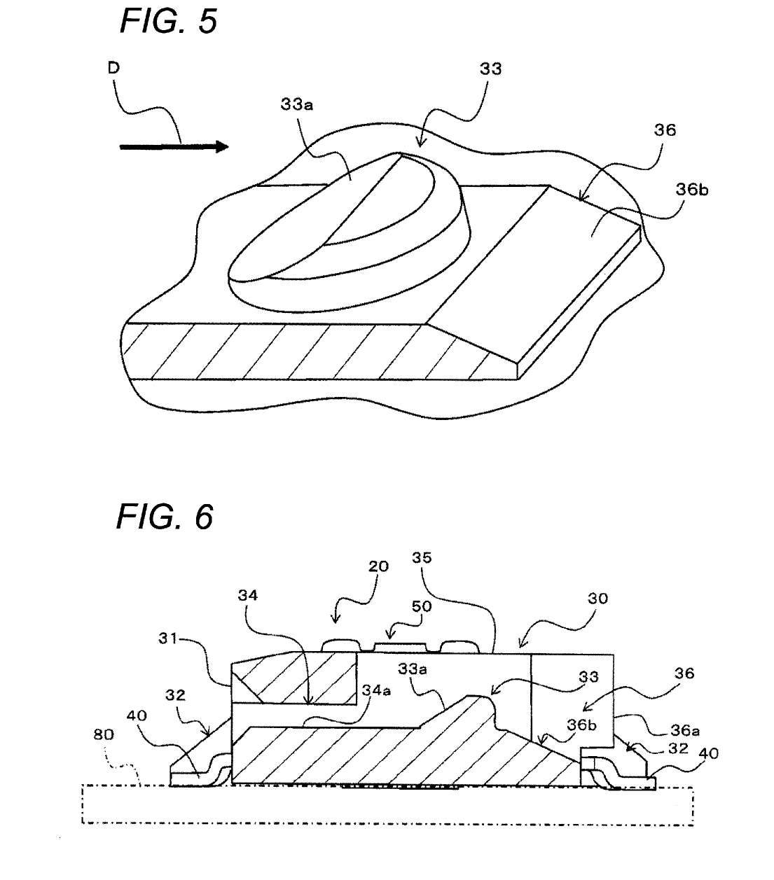

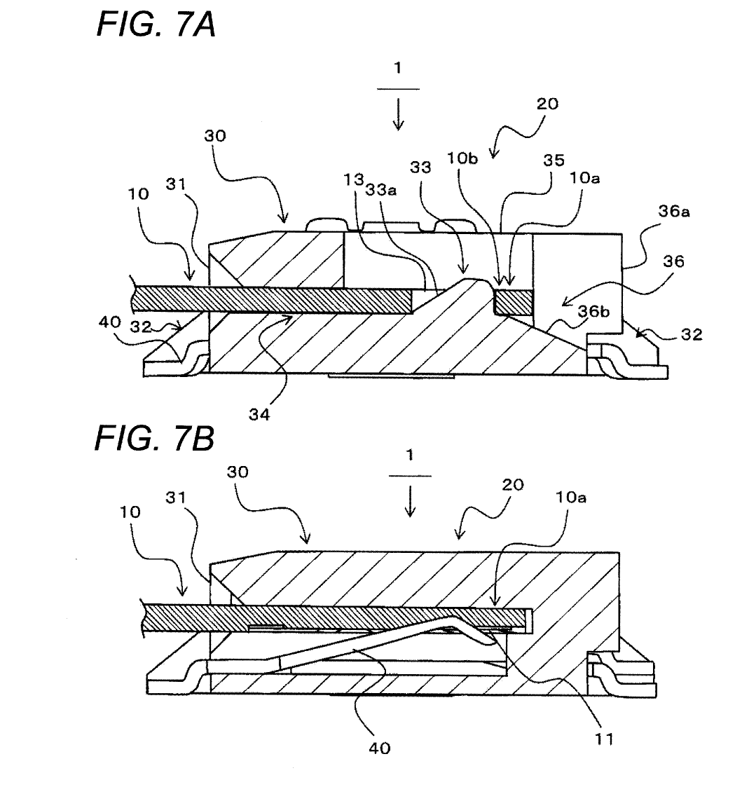

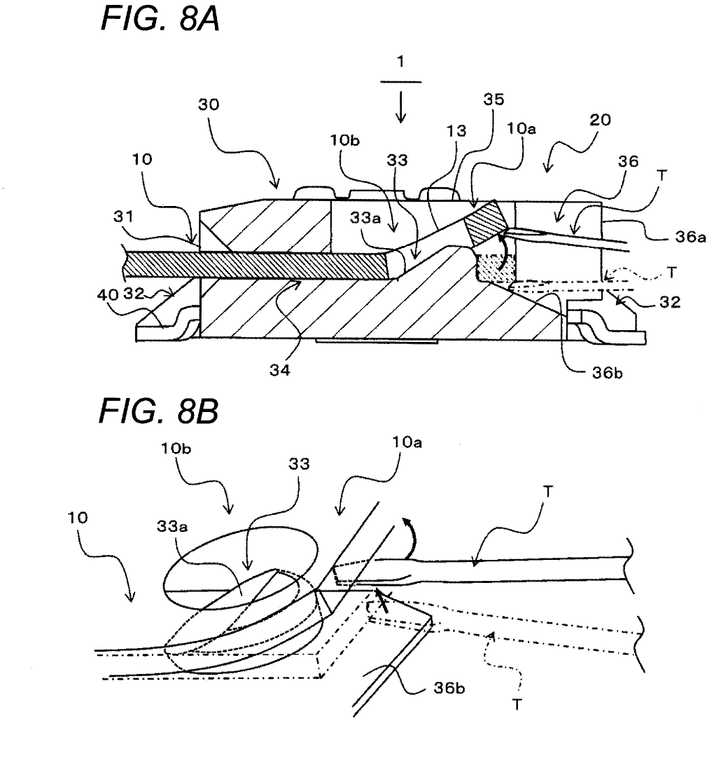

FIG. 1 is an exploded perspective view of a connection mechanism 1 of a flat circuit body and a connector according to an embodiment of the invention. FIG. 2 is a perspective view of a connector 20. FIG. 3 is a perspective view of a flat circuit body 10 observed from a surface where electrodes 11 have been formed. FIG. 4A is a top view of a connector housing 30, and FIG. 4B is an enlarged view of the vicinity of an engagement protrusion 33 in the connector housing 30. FIG. 5 is a perspective view of the vicinity of the engagement protrusion 33, which is partially shown in section. FIG. 6 is a sectional view taken on line A-A, showing the connector 20 shown in FIG. 2. FIG. 7A is a sectional view of the connector 20 and the flat circuit body 10 around an engagement protrusion 33 and an engagement hole 13 that are in engagement with each other, and FIG. 7B is a sectional view of the connector 20 and the flat circuit body 10, showing a section in a different position from that of FIG. 7A. FIGS. 8A and 8B are views for explaining that the engagement between the engagement hole 13 and the engagement protrusion 33 is released by use of an engagement release jig T. FIG. 8A shows a sectional view of the flat circuit body 10 and the connector 20, and FIG. 8B shows a perspective view around the engagement hole 13 and the engagement protrusion 33 corresponding to FIG. 8A.

Incidentally, in FIG. 6, a circuit board 80 serving as a fixing destination of the connector housing 30 is depicted by an imaginary line.

In the connection mechanism 1 of a flat circuit body and a connector according to the embodiment of the invention, an end portion 10a of the flat circuit body 10 such as a flexible printed circuit or a flexible flat cable is inserted into the connector housing 30 of the connector 20 while sliding thereon, so that electrodes 11 formed in the end portion 10a can be connected to terminals 40 in the connector housing 30.

First, description will be made about the flat circuit body 10.

The flat circuit body 10 is, for example, implemented by a flexible printed circuit. The flat circuit body 10 is a flat flexible circuit board in which circuit wiring is formed out of a conductive metal film on an insulating resin sheet, and the surface of the insulating resin sheet is covered with an insulating protective film to thereby protect the circuit wiring.

In addition, in the flat circuit body 10, a plurality of electrodes 11 are formed in parallel as circuit wiring on one surface of the end portion 10a. The insulating protective film is partially removed to expose connection surfaces of the respective electrodes 11. In this manner, the electrodes 11 exposed to the outside are connected to the terminals 40 provided in the connector 20 respectively.

In addition, in the flat circuit body 10, a reinforcing plate 12 is pasted to a surface on the opposite side to the side where the electrodes 11 are exposed. The reinforcing plate 12 is pasted to the end portion 10a of the flat circuit body 10 in order to reinforce the end portion 10a. Incidentally, in the embodiment, a flexible plate is used as the reinforcing plate 12.

Further, in the flat circuit body 10, a pair of engagement holes 13 and 13 are formed in both corner portions 10b and 10b of the end portion 10a so as to penetrate the flat circuit body 10. Each of the pair of engagement holes 13 and 13 has a circular outer shape that can engage with a corresponding one of a pair of engagement protrusions 33 and 33 of the connector housing 30, which will be described later.

Incidentally, in the embodiment, in the flat circuit body 10, a pair of engagement holes 13 and 13 are formed not only in the end portion 10a on the side where the flat circuit body 10 is inserted into the connector housing 30 according to the embodiment, but another pair of engagement holes 13 and 13 are also formed in the other end portion.

Next, description will be made about the connector 20.

The connector 20 includes the connector housing 30, and a plurality of terminals 40 provided in the connector housing 30. The connector housing 30 is fixed to a fixing destination such as a circuit board 80 by a pair of fixing fixtures 50 and 50.

The connector housing 30 is made of an insulating resin material such as synthetic resin. The connector housing 30 has an approximately rectangular parallelepiped outline shape.

The terminals 40 are fixed to the inside of the connector housing 30. The end portion 10a of the flat circuit body 10 is inserted into the connector housing 30 through an insertion port 31, and fixed in a state where the electrodes 11 and the terminals 40 are connected respectively in positions where the flat circuit body 10 has been completely inserted into the connector housing 30.

In addition, fixture fixing portions 37 to which the fixing fixtures 50 can be fitted and fixed respectively are provided in the longitudinally opposite side portions of the connector housing 30. The fixing fixtures 50 fixed to the fixture fixing portions 37 are fixed to the circuit board 80 so that the connector housing 30 can be fixed to the circuit board 80 as a fixing destination.

In addition, a pair of rotation preventing ribs 32 are provided in each of the longitudinal end portions of the connector housing 30 so as to prevent the connector housing 30 from rotating with the fixing fixtures 50 and 50 as fulcrums relatively to the circuit board 80.

Each pair of rotation preventing ribs 32 are provided to protrude forward and rearward with respect to a corresponding one of the fixing fixtures 50. In addition, the bottoms of the rotation preventing ribs 32 form parts of the bottom of the connector housing 30.

That is, the paired rotation preventing ribs 32 protrude in opposite directions to each other with respect to the fixing fixture 50 placed therebetween. In addition, the paired rotation preventing ribs 32 form parts of the bottom of the connector housing 30. Thus, the connecting area of the connector housing 30 to the circuit board 80 as a fixing destination can be enlarged on the opposite sides of the fixing fixture 50. Accordingly, the bottoms of the paired rotation preventing ribs 32 abut against the circuit board 80 to prevent the connector housing 30 from rotating in the left and right rotation directions respectively when the connector housing 30 is to rotate using the fixing fixture 50 as a fulcrum.

For example, the flat circuit body 10 connected to the connector 20 may be pulled in the up/down direction so that a force to rotate the connector housing 30 with the fixing fixtures 50 and 50 as fulcrums can act on the connector housing 30. Even in such a case, the bottoms of the pairs of rotation preventing ribs 32 configured thus prevent the connector housing 30 from rotating. As a result, solder in the terminals 40 soldered with the circuit boards 80 can be prevented from being damaged.

Incidentally, in the embodiment, the pairs of rotation preventing ribs 32 are provided to protrude forward and rearward in the longitudinally opposite portions of the connector housing 30 respectively by way of example. However, the rotation preventing ribs 32 are not limited thereto. At least a pair of rotation preventing ribs 32 may be provided to protrude in opposite directions to each other with respect to each fixing fixture 50 placed therebetween and to form parts of the bottom of the connector housing 30.

In addition, the connector housing 30 has a pair of engagement protrusions 33 and 33, a movement regulating portion 34, circuit body escape portions 35, and jig insertion paths 36. The pair of engagement protrusions 33 and 33 engage with the pair of engagement holes 13 and 13 respectively. The movement regulating portion 34 regulates the movement of the flat circuit body 10. The circuit body escape portions 35 can bend the vicinities of the both corner portions 10b and 10b including the pair of engagement holes 13 and 13 of the flat circuit body 10 respectively. Each jig insertion path 36 serves as a path through which a jig T can be inserted into the connector housing 30.

The pair of engagement protrusions 33 and 33 protrude so that the engagement protrusions 33 and 33 can engage with the pair of engagement holes 13 and 13 in positions where the flat circuit body 10 has been completely inserted to connect the electrodes 11 with the terminals 40. In addition, the pair of engagement protrusions 33 and 33 form guide portions 33a for guiding the pair of engagement holes 13 and 13 to top portions of the engagement protrusions 33 and 33 when the flat circuit body 10 is inserted.

In the embodiment, the guide portions 33a are slopes that are inclined upward in an insertion direction D of the flat circuit body 10 so that the pair of engagement holes 13 and 13 can be guided to the top portions.

Incidentally, the guide portions 33a are not limited to the slopes, for example, the guide portions 33a may be portions shaped into curved surfaces as long as they can guide the engagement hole 13 to the top portions of the engagement protrusions 33 respectively.

More specifically, as shown in FIG. 4A to FIG. 6, each of the engagement protrusions 33 and 33 protrudes like a column from a surface continuously extending in the insertion direction D of the flat circuit body 10 further from a lower surface 34a of the movement regulating portion 34, so as to form a guide portion 33a on the side where the flat circuit body 10 is inserted into the connector housing 30 to abut against the connector housing 30. The guide portion 33a forms a gentle slope by which the corner portion 10b of the flat circuit body 10 inserted into the connector housing 30 and sliding thereon is guided to the top of the engagement protrusion 33 easily so that the corner portion 10b can get over the engagement protrusion 33 to engage the engagement hole 13 and the engagement protrusion 33 with each other.

The movement regulating portion 34 is a part in which a pair of walls opposed to each other at a distance slightly larger than the thickness of the end portion 10a form an insertion path of the end portion 10a around the pair of engagement protrusions 33 and 33 and on the insertion port 31 side of the flat circuit body 10 with respect to the pair of engagement protrusions 33 and 33. Thus, the movement regulating portion 34 regulates the movement of the flat circuit body 10 in the thickness direction thereof so that the pair of engagement holes 13 and 13 can be positioned to engage with the pair of engagement protrusions 33 and 33.

The lower surface 34a in FIG. 6, which forms the movement regulating portion 34, extends to the position where each engagement protrusion 33 is provided in the insertion direction D of the flat circuit body 10.

The circuit body escape portions 35 are arranged to form openings by which the vicinities of the both corner portions 10b and 10b of the flat circuit body 10 including the pair of engagement holes 13 and 13 respectively can be bent in a direction to escape from a movement regulating range defined by the movement regulating portion 34, so that each of the engagement holes 13 can be engaged with a corresponding one of the engagement protrusions 33 and can be released from engagement with the engagement protrusion 33.

More specifically, the circuit body escape portions 35 are arranged to form openings by which the vicinities of the both corner portions 10b and 10b of the flat circuit body 10 including the pair of engagement holes 13 and 13 respectively can be bent to get over the top portions of the engagement protrusions 33 respectively, so that each of the engagement holes 13 can be engaged with a corresponding one of the engagement protrusions 33 and can be released from engagement with the engagement protrusion 33.

That is, the circuit body escape portions 35 are openings that are provided in the longitudinally opposite end portions of the connector housing 30 correspondingly to the engagement protrusions 33 and 33 respectively. The openings are formed above the pair of engagement protrusions 33 and 33 respectively so that the vicinities of the both corner portions 10b and 10b can be bent upward.

Each jig insertion path 36 serves as a path through which the jig T can be inserted from the outside of the connector housing 30 to the inside thereof in order to bend the vicinity of a corresponding one of the both corner portions 10b and 10b by means of a corresponding one of the circuit body escape portions 35 to thereby release the engagement between a corresponding one of the engagement holes 13 and a corresponding one of the engagement protrusions 33. Incidentally, any jig may be used as the jig T as long as it can bend the vicinity of each corner portion 10b of the flat circuit body 10. For example, an existing flat-bladed screwdriver may be used.

Each jig insertion path 36 forms a jig insertion guide slope 36b, which is a surface formed in a surface where a corresponding one of the engagement protrusions 33 and 33 protrudes. The jig insertion guide slope 36b is inclined downward toward a corresponding jig insertion port 36a serving as a port through which the jig T can be inserted from the vicinity of a corresponding one of the engagement protrusions 33 and 33. In addition, the jig insertion guide slope 36b guides the jig T so that the jig T can be pushed in a direction to escape from the movement regulating range defined by the movement regulating portion 34, and pressed against a surface of a corresponding one of the both corner portions 10b and 10b of the flat circuit body 10 in which the pair of engagement holes 13 and 13 has engaged with the pair of engagement protrusions 33 and 33.

Incidentally, each jig insertion port 36a is formed in a surface opposite to the insertion port 31 of the connector housing 30, so that the jig T can be inserted into the connector housing 30 from the front end side of the flat circuit body 10 that has been completely inserted into the connector housing 30.

In addition, each jig insertion path 36 forms an opening continuously extending from a corresponding one of the jig insertion ports 36a to a corresponding one of the circuit body escape portions 35. Thus, the jig T inserted into the connector housing 30 through the jig insertion path 36 can be prevented from interfering with the wall of the connector housing 30 easily, and can be operated easily to bend the vicinity of the corresponding corner portion 10b of the flat circuit body 10 due to the jig insertion path 36.

Assume that the jig T is inserted from the outside of the connector housing 30 to the inside thereof toward one of the corner portion 10b of the flat circuit body 10 that has been completely inserted into the connector housing 30. In this case, as shown in FIGS. 8A and 8B, the front end of the jig T is inserted sliding on the jig insertion guide slope 36b so that the front end of the jig T can be disposed under the corner portion 10b.

Thus, when the front end of the jig T is pushed upward from below the corner portion 10b so as to bend the vicinity of the corner portion 10b upward, the engagement between the engagement hole 13 and the engagement protrusion 33 can be released.

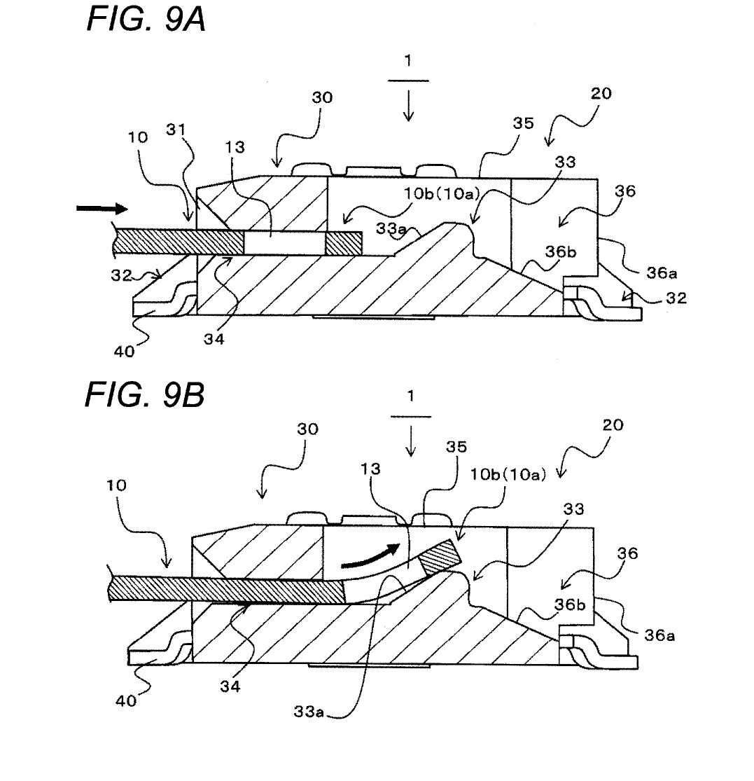

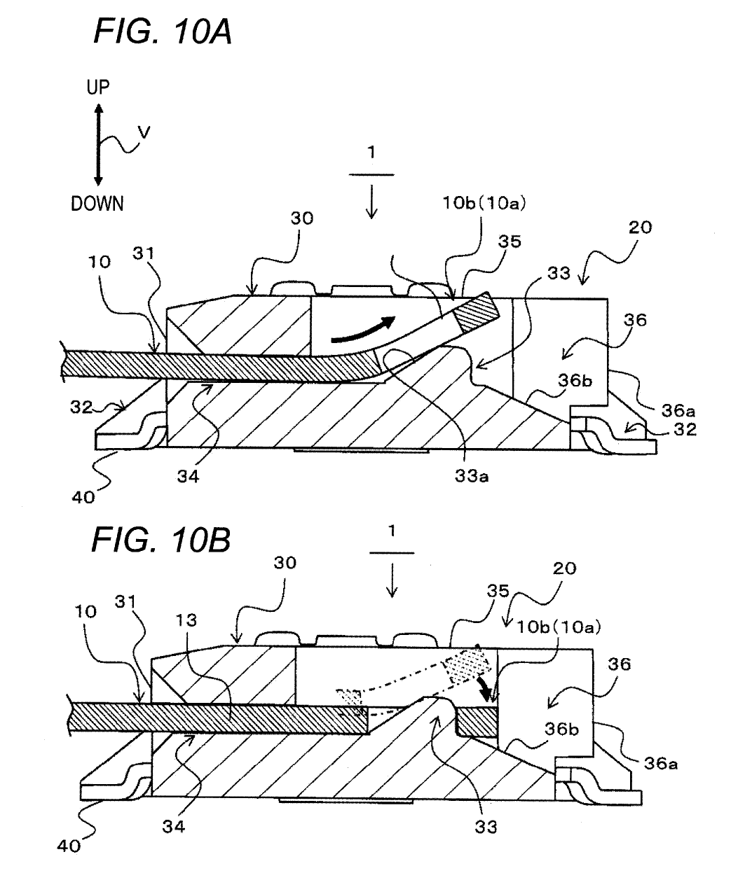

Next, with reference to FIGS. 9A and 9B and FIGS. 10A and 10B, description will be made about the procedure and the operation of each portion in which the end portion 10a of the flat circuit body 10 is inserted into the connector housing 30 of the connector 20 while sliding thereon so as to connect the electrodes 11 formed in the end portion 10a with the terminals 40 in the connector housing 30.

FIG. 9A is a sectional view of the flat circuit body 10 and the connector 20 in a state where inserting the end portion 10a of the flat circuit body 10 into the connector housing 30 of the connector 20 while sliding the end portion 10a thereon has been begun, and FIG. 9B is a sectional view of the flat circuit body 10 and the connector 20 in a state where the flat circuit body 10 in the state of FIG. 9A has been further slid and moved toward an insertion completion position. FIG. 10A is a sectional view of the flat circuit body 10 and the connector 20 in a state where the flat circuit body 10 in the state of FIG. 9B has been further slid and moved toward the insertion completion position, and FIG. 10B is a sectional view of the flat circuit body 10 and the connector 20 in a state where the flat circuit body 10 has been completely moved to the insertion completion position.

Incidentally, for convenience, description will be made on the assumption that the direction of the arrow V shown in FIGS. 9A and 9B and FIGS. 10A and 10B is an up/down direction.

First, an operator begins to insert the end portion 10a of the flat circuit body 10 into the connector housing 30 from the insertion port 31 of the connector housing 30 while sliding and moving the end portion 10a thereon and therein (see FIG. 9A). On this occasion, the end portion 10a of the flat circuit body 10 is slid and moved toward an insertion completion position in a state where the movement of the flat circuit body 10 in the up/down direction is regulated by the movement regulating portion 34.

The operator slides and moves the flat circuit body 10 further toward the insertion completion position (see FIG. 9B). Then, the flat circuit body 10 slides and moves while the lower surfaces of the both corner portions 10b and 10b of the end portion 10a get over the guide portions 33a and 33a respectively.

Here, the movement of the flat circuit body 10 in the up/down direction is regulated by the movement regulating portion 34. Therefore, the flat circuit body 10 slides and moves while bending the both corner portions 10b and 10b upward from their heights defined by the movement regulating portion 34.

After that, the operator slides and moves the flat circuit body 10 further toward the insertion completion position (see FIG. 10A). Then, the front ends of the both corner portions 10b and 10b bent upward are located above the upper surface of the connector housing 30. However, due to the openings serving as the circuit body escape portions 35, the flat circuit body 10 can continue to slide and move toward the insertion completion position without interfering with the connector housing 30.

After that, when the operator completely moves the flat circuit body 10 to the insertion completion position, the engagement holes 13 engage with the engagement protrusions 33 corresponding thereto respectively. Thus, this working is completed (see FIG. 10B). When the flat circuit body 10 is completely moved to the insertion completion position, the engagement holes 13 reach the positions where they can engage with the engagement protrusions 33 corresponding thereto respectively. The both corner portions 10b and 10b that have been bent upward are elastically restored so that the engagement holes 13 can engage with the engagement protrusions 33 corresponding thereto respectively.

Here, the flat circuit body 10 is retained in a position in the up/down direction by the movement regulating portion 34 so that the engagement holes 13 can engage with the engagement protrusions 33 respectively. Accordingly, there is no fear that the flat circuit body 10 may leave the connector housing 30 unless the both corner portions 10b and 10b are bent upward by an external force.

Incidentally, in order to release the engagement between the engagement hole 13 and the engagement protrusion 33 corresponding to each other, the jig T is inserted into the connector housing 30 through the jig insertion path 36 as described above (see FIGS. 8A and 8B).

In the connector 20 according to the embodiment of the invention, a member called a slider for fixing the flat circuit body 10 with the connector 20 in the position where the flat circuit body 10 and the connector 20 are completely connected to each other is not installed in the end portion 10a of the flat circuit body 10, but the pair of engagement holes 13 and 13 formed in the flat circuit body 10 and the pair of engagement protrusions 33 and 33 formed in the connector housing 30 can be engaged with each other in the following manner. That is, due to the effect of the movement regulating portion 34 regulating the movement of the flat circuit body 10 and the guide effect of the guide portions 33a, the vicinities of the both corner portions 10b and 10b of the flat circuit body 10 can be elastically bent upward in the circuit body escape portions 35 so as not to interfere with the wall of the connector housing 30. When the vicinities of the both corner portions 10b and 10b bent thus are elastically restored, the pair of engagement holes 13 and 13 and the pair of engagement protrusions 33 and 33 can be engaged with each other. Accordingly, the number of components can be suppressed to be small. It is therefore possible to reduce the manufacturing cost.

In the connection mechanism 1 of a flat circuit body and a connector according to the embodiment of the invention, a member called a slider for fixing the flat circuit body 10 with the connector 20 in the position where the flat circuit body 10 and the connector 20 are completely connected to each other is not installed in the end portion 10a of the flat circuit body 10, but the pair of engagement holes 13 and 13 formed in the flat circuit body 10 and the pair of engagement protrusions 33 and 33 formed in the connector housing 30 can be engaged with each other in the following manner. That is, due to the effect of the movement regulating portion 34 regulating the movement of the flat circuit body 10 and the guide effect of the guide portions 33a, the vicinities of the both corner portions 10b and 10b of the flat circuit body 10 can be elastically bent upward in the circuit body escape portions 35 so as not to interfere with the wall of the connector housing 30. When the vicinities of the both corner portions 10b and 10b bent thus are elastically restored, the pair of engagement holes 13 and 13 and the pair of engagement protrusions 33 and 33 can be engaged with each other. Accordingly, the number of components can be suppressed to be small. It is therefore possible to reduce the manufacturing cost.

In addition, in the connection mechanism 1 of a flat circuit body and a connector according to the embodiment of the invention, the movement regulating portion 34 forms an insertion path of the end portion 10a around the pair of engagement protrusions 33 and 33 and on the insertion port 31 side of the flat circuit body 10 with respect to the pair of engagement protrusions 33 and 33, and the insertion path is formed out of a pair of walls opposed at a distance slightly larger than the thickness of the end portion 10a. Accordingly, the movement of the flat circuit body 10 in the thickness direction is regulated so that the pair of engagement holes 13 and 13 can be positioned to engage with the pair of engagement protrusions 33 and 33. It is therefore possible to stably maintain the state where the pair of engagement holes 13 and 13 engage with the pair of engagement protrusions 33 and 33.

In addition, in the connection mechanism 1 of a flat circuit body and a connector according to the embodiment of the invention, the jig T is inserted from the outside of the connector housing 30 to the inside thereof by use of each jig insertion path 36 so that the vicinities of the both corner portions 10b and 10b can be bent in the circuit body escape portions 35. Thus, the engagement between the engagement holes 13 and 13 and the engagement protrusions 33 and 33 can be released easily.

In addition, in the connection mechanism 1 of a flat circuit body and a connector according to the embodiment of the invention, when the engagement between the engagement hole 13 and the engagement protrusion 33 corresponding to each other is released by use of the jig T, the front end of the jig is inserted sliding on a corresponding one of the jig insertion guide slopes 36b so that the front end of the jig T can be disposed toward the surface of a corresponding one of the corner portions 10b. Accordingly, when the front end of the jig T is pressed against the surface to bend the vicinity of the corner portion 10b in a direction to escape from the movement regulating range defined by the movement regulating portion 34, the engagement between the engagement hole 13 and the engagement protrusion 33 corresponding to each other can be released easily.

In addition, in the connection mechanism 1 of a flat circuit body and a connector according to the embodiment of the invention, an opening can be formed on the protruding direction side of each engagement protrusion 33 so as to continuously extend from the corresponding jig insertion port 36a to the corresponding circuit body escape portion 35 that is an opening. Accordingly, when the jig T is inserted into the connector housing 30, the connector housing 30 can be prevented from easily interfering with the jig T. Thus, the jig T can be operated more easily to release the engagement between the engagement hole 13 and the engagement protrusion 33 corresponding to each other.

In addition, in the connection mechanism 1 of a flat circuit body and a connector according to the embodiment of the invention, a pair of rotation preventing ribs 32 and 32 protrude in opposite directions to each other with respect to each fixing fixture 50 placed therebetween, and form parts of the bottom of the connector housing 30, so that the connecting area of the connector housing 30 to the circuit board 80 serving as a fixing destination can be enlarged on the opposite sides of the fixing fixture 50. Accordingly, the bottoms of the pair of rotation preventing ribs 32 and 32 abut against the circuit board 80 to prevent the connector housing 30 from rotating in the left and right rotation directions respectively when the connector housing 30 is to rotate using the fixing fixture 50 as a fulcrum. Thus, even when each terminal 40 is soldered with the circuit board 80 by a solder, the solder can be prevented from being damaged by a load applied onto the terminal 40 due to the rotation of the connector housing 30. As a result, the electric connection between the terminal and the fixing destination can be prevented from lowering.

(Modification 1)

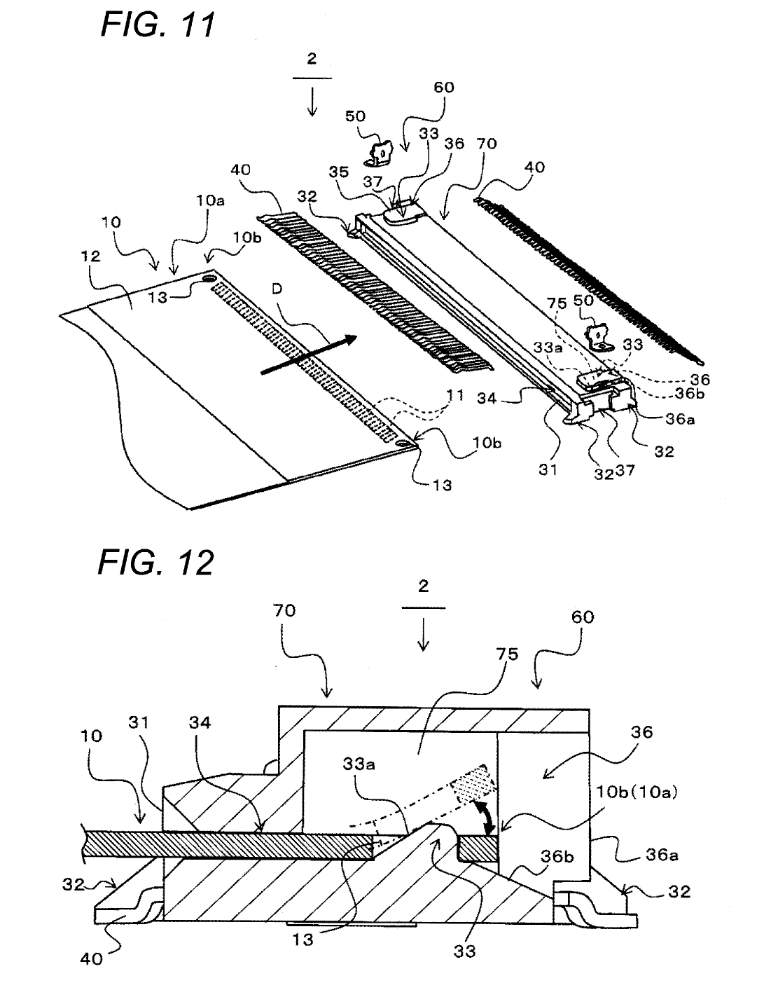

Next, Modification 1 of the connection mechanism 1 of a flat circuit body and a connector according to the embodiment of the invention will be described with reference to FIG. 11 and FIG. 12.

FIG. 11 is an exploded perspective view of a connection mechanism 2 of a flat circuit body 10 and a connector 60 according to Modification 1. FIG. 12 is a sectional view of the connector 60 and the flat circuit body 10 around an engagement protrusion 33 and an engagement hole 13 that are in engagement with each other in the connection mechanism 2 of a flat circuit body and a connector according to Modification 1.

Incidentally, in FIG. 12, a corner portion 10b bent to establish engagement between an engagement hole 13 and an engagement protrusion 33 or to release the engagement is depicted by view of an imaginary line.

The connection mechanism 2 of a flat circuit body and a connector according to Modification 1 is different from the connection mechanism 1 of a flat circuit body and a connector according to the embodiment at the point that circuit body escape portions 75 are different.

Incidentally, the other configuration is similar to that of the embodiment. Constituent components the same as those in the embodiment are referenced correspondingly.

The circuit body escape portions 75 in the connection mechanism 2 of a flat circuit body and a connector according to Modification 1 form spaces in which the vicinities of the both corner portions 10b and 10b of the flat circuit body 10 including the pair of engagement holes 13 and 13 respectively can be bent upward from the height defined by the movement regulating portion 34, so that each of the engagement holes 13 can be engaged with a corresponding one of the engagement protrusions 33 and can be released from engagement with the engagement protrusion 33.

More specifically, the circuit body escape portions 75 form spaces that are provided in the longitudinally opposite end portions of a connector housing 70 correspondingly to the engagement protrusions 33 and 33 respectively, so that the vicinities of the both corner portions 10b and 10b can be bent upward.

That is, the circuit body escape portions 75 form spaces in which walls around the pair of engagement protrusions 33 and 33 can be prevented from interfering even when the walls are bent upward so that engagement between each of the engagement holes 13 and a corresponding one of the engagement protrusions 33 can be established and the engagement can be released around the both corner portions 10b and 10b.

In the connection mechanism 2 of a flat circuit body and a connector according to Modification 1, a member called a slider for fixing the flat circuit body 10 with the connector 60 in the position where the flat circuit body 10 and the connector 60 are completely connected to each other is not installed in the end portion 10a of the flat circuit body 10, but the pair of engagement holes 13 and 13 formed in the flat circuit body 10 and the pair of engagement protrusions 33 and 33 formed in the connector housing 70 can be engaged with each other in the following manner. That is, due to the effect of the movement regulating portion 34 regulating the movement of the flat circuit body 10 and the guide effect of the guide portions 33a, the vicinities of the both corner portions 10b and 10b of the flat circuit body 10 can be elastically bent upward in the circuit body escape portions 75 so as not to interfere with the wall of the connector housing 70. When the vicinities of the both corner portions 10b and 10b bent thus are elastically restored, the pair of engagement holes 13 and 13 and the pair of engagement protrusions 33 and 33 can be engaged with each other. When the jig T is inserted into each jig insertion path 36, the vicinities of the both corner portions 10b and 10b can be bent upward to release the engagement between the pair of engagement holes 13 and 13 and the pair of engagement protrusions 33 and 33. Accordingly, in the same manner as in the connection mechanism 1 of a flat circuit body and a connector according to the embodiment, the number of components can be suppressed to be small. It is therefore possible to reduce the manufacturing cost.

(Modification 2)

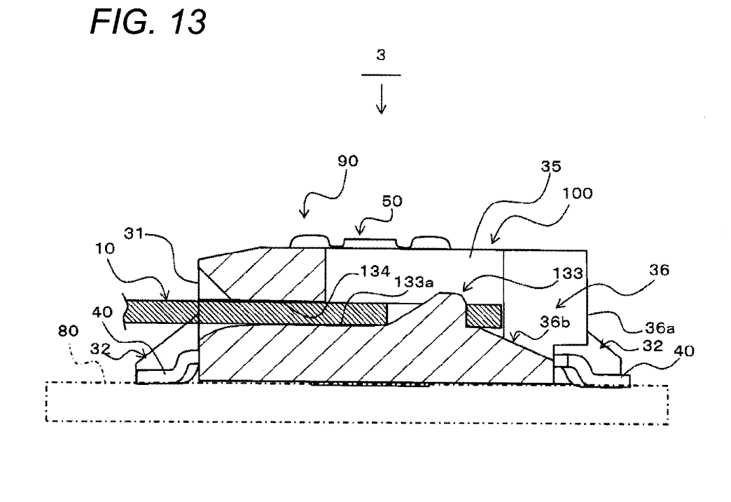

Next, Modification 2 of the connection mechanism 1 of a flat circuit body and a connector according to the embodiment of the invention will be described with reference to FIG. 13.

FIG. 13 is a sectional view of a connection mechanism 3 of a flat circuit body and a connector according to Modification 2.

The connection mechanism 3 of a flat circuit body and a connector according to Modification 2 is different from the connection mechanism 1 of a flat circuit body and a connector according to the embodiment at the point that guide portions 133a of respective engagement protrusions 133 and 133 are formed to extend to the insertion port 31.

Incidentally, the other configuration is similar to that of the embodiment. Constituent components the same as those in the embodiment are referenced correspondingly.

In the connection mechanism 3 of a flat circuit body and a connector according to Modification 2, each guide portion 133a guides one surface of the flat circuit body 10 from the insertion port 31 to a top portion of the corresponding engagement protrusion 133.

Accordingly, a movement regulating portion 134 is a wall extending from the insertion port 31 to the vicinity of each engagement protrusion 133. The movement regulating portion 134 regulates the movement of the flat circuit body 10 so that a corresponding engagement hole 13 can be positioned to engage with the engagement protrusion 133.

In the connection mechanism 3 of a flat circuit body and a connector according to Modification 2, in the same manner as in the embodiment, the number of components can be suppressed to be small. It is therefore possible to reduce the manufacturing cost.

Incidentally, a connector including jig insertion paths 36 has been described by way of example as each of the connectors 20, 60 and 90 according to the embodiment of the invention and Modifications 1 and 2. Each connector 20, 60, 90 is not limited thereto, but may be a connector having no jig insertion path 36. The connector 20, 60, 90 having no jig insertion path 36 thus can deal with specifications in which the flat circuit body 10 does not have to be removed from the connector 20, 60, 90 without being damaged.

The invention developed by the inventor has been described specifically based on the aforementioned embodiment of the invention. However, the invention is not limited to the aforementioned embodiment of the invention, but various changes can be made on the invention without departing from the gist thereof.

What is claimed is:

1. A connector comprising:
a connector housing to which a flat circuit body comprising an electrode formed in an end portion thereof is allowed to be slidably inserted; and
a terminal which is provided inside the connector housing and which is connected to the electrode when the end portion is inserted into the connector housing,
wherein the connector housing comprises:
a pair of engagement protrusions which protrude to engage, at a position where the flat circuit body has been completely inserted to connect the terminal with the electrode, with a pair of engagement holes formed in both corner portions of the end portion to penetrate the flat circuit body, the engagement protrusions comprising guide portions formed to guide the pair of engagement holes to top portions of the engagement protrusions when the flat circuit body is inserted;
a movement regulating portion which regulates movement of the flat circuit body such that the pair of engagement holes are positioned to engage with the pair of engagement protrusions; and
a circuit body escape portion which forms a space or an opening in which peripheral portions of the both corner portions including the pair of engagement holes in the flat circuit body are bendable so as to escape from a movement regulating range defined by the movement regulating portion such that engagement of the engagement hole and the engagement protrusion corresponding to each other is established and released.

2. A connection mechanism of a flat circuit body and a connector, the connection mechanism comprising:
a flat circuit body comprising an electrode formed in an end portion thereof; and
a connector comprising:
a connector housing to which the flat circuit body is allowed to be slidably inserted; and
a terminal which is provided inside the connector housing and which is connected to the electrode when the end portion is inserted into the connector housing of the connector,
wherein the flat circuit body has:
a pair of engagement holes formed in both corner portions of the end portion to penetrate the flat circuit body, and
wherein the connector housing comprises:
a pair of engagement protrusions which protrude to engage with the pair of engagement holes at a position where the flat circuit body has been completely inserted to connect the terminal with the electrode, the engagement protrusions comprising guide portions formed to guide the pair of engagement holes to top portions of the engagement protrusions when the flat circuit body is inserted;
a movement regulating portion which regulates movement of the flat circuit body such that the pair of engagement holes are positioned to engage with the pair of engagement protrusions; and
a circuit body escape portion which forms a space or an opening in which peripheral portions of the both corner portions including the pair of engagement holes in the flat circuit body is bendable so as to escape from a movement regulating range defined by the movement regulating portion such that engagement of the engagement hole and the engagement protrusion corresponding to each other is established and released.

3. The connection mechanism of a flat circuit body and a connector according to claim 2,
wherein the connector housing comprises an insertion port through which the flat circuit body is allowed to be inserted,
wherein the movement regulating portion comprises an insertion path formed around the pair of engagement protrusions and closer to the insertion port than the pair of engagement protrusions,
wherein the insertion path is formed by a pair of walls opposing with a distance slightly larger than thickness of the end portion, and
wherein the movement regulating portion regulates movement of the flat circuit body such that the pair of engagement holes are positioned to engage with the pair of engagement protrusions.

4. The connection mechanism of a flat circuit body and a connector according to claim 2, further comprising:
a jig insertion paths serving as a path in which a jig for releasing engagement is allowed to be inserted into the connector housing from an outside of the connector housing through a jig insertion port such that the peripheral portions of the both corner portions are bent in the circuit body escape portion to release engagement of the engagement hole and the engagement protrusion corresponding to each other.

5. The connection mechanism of a flat circuit body and a connector according to claim 4,
wherein the jig insertion path comprises a jig insertion guide slope formed in a surface of the housing from which the pair of engagement protrusions protrude,
wherein the jig insertion guide slope is a surface formed to be inclined downward toward the jig insertion port from a vicinity of each of the pair of engagement protrusions, and
wherein the jig insertion guide slope guides the jig such that the jig is pressed, in a direction to escape from the movement regulating range defined by the movement regulating portion, against a surface of each of the both corner portions of the flat circuit body in a state in which the pair of engagement holes are engaged with the pair of engagement protrusions.

6. The connection mechanism of a flat circuit body and a connector according to claim 4,
wherein the circuit body escape portion is an opening formed on a protruding direction side of each of the pair of engagement protrusions so as to allow the peripheral portions of the both corner portions to be bent in a direction to escape from the movement regulating range defined by the movement regulating portion, and
wherein the jig insertion path forms an opening which continuously extends from the jig insertion port to the circuit body escape portion.

7. The connection mechanism of a flat circuit body and a connector according to claim 2,
wherein the connector housing comprises at least a pair of rotation preventing ribs which are fixed to a fixing destination of the connector housing by a fixing fixture, which protrude in opposite directions to each other with respect to the fixing fixture placed therebetween, and which form part of a bottom surface of the connector housing.
